(19) United States
(12) Patent Application Publication
(10) Pub. No.: US 2017/0064584 A1
(43) Pub. Date: Mar. 2, 2017

(54) Solution to Skip Authentication Procedure During Circuit-Switched Fallback (CSFB) to Shorten Call Setup Time

(71) Applicant: Intel IP Corporation, Santa Clara, CA (US)

(72) Inventors: Chang Hong Shan, Shanghai (CN); Jerome Parron, Fuerth (DE)

(21) Appl. No.: 15/119,856

(22) PCT Filed: Mar. 27, 2015
(86) PCT No.: PCT/US2015/022960

§ 371 Date: Aug. 18, 2016

Related U.S. Application Data
(60) Provisional application No. 61/985,386, filed on Apr. 28, 2014.

(51) Int. Cl. H04W 36/00; H04W 76/02; H04W 12/04; H04L 29/06

(52) U.S. Cl. CPC H04W 36/0022; H04L 63/0853; H04W 76/02; H04W 12/04; H04J 11/00

(57) ABSTRACT

A User Equipment (UE) device or network system facilitates a Circuit Switched Fallback (CSFB) procedure to enable fallback from a Long Term Evolution (LTE) network to a circuit switched domain network. A network device or a UE can operate to skill skip an authentication procedure during CSFB procedures and shorten a call setup time. A key access security management entity (K_{ASME}) is acquired. An extended service request message is communicated, or received, to originate the CSFB process from a first network of a first network device to a second network of a second network device in response to a mobile originating call or a mobile terminating call. A plurality of circuit switched (CS) key parameters is derived from the K_{ASME}, and the CSFB procedure is generated based on the plurality of CS key parameters.

### REFERENCE TO RELATED APPLICATIONS

This application claims the benefit of U.S. Provisional Application No. 61/985,386 filed Apr. 28, 2014, entitled “SOLUTION TO SKIP AUTHENTICATION PROCEDURE DURING CSFB TO SHORTEN CALL SETUP TIME”, the contents of which are herein incorporated by reference in their entirety.

### FIELD

The present disclosure relates to circuit switched fallback (CSFB), and more specifically, to shortening call setup times by skipping authentication procedures during circuit switched fallback operations.

### BACKGROUND

In a conventional public land mobile network (PLMN), such as according to the 3rd Generation Partnership Project (3GPP), various radio access networks (RANs), such as a General Packet Radio Subsystem Evolved Radio Access Network (GERAN), a Universal Mobile Telecommunications System Terrestrial Radio Access Network (UTRAN), and an Evolved-UTRAN (E-UTRAN) may be connected to a common core network and provide various services. For example, GERAN or UTRAN may provide voice services, solely or in part, while E-UTRAN, by contrast, may provide packet services, either solely or in part. Difficulties, including a long duration for call setup times, exist within Circuit Switched Fallback (CSFB) processes that enable fallback from Long Term Evolution (LTE) networks to Circuit Switched domain networks.

### BRIEF DESCRIPTION OF THE DRAWINGS

FIG. 1 is a block diagram illustrating a mobile network according to various aspects disclosed.

FIG. 2 is a block diagram illustrating a block diagram of a mobile network architecture for circuit-switched fallback according to various aspects disclosed.

FIG. 3 is a data flow illustrating a circuit-switched fallback procedure according to various aspects disclosed.

FIG. 4 is another data flow illustrating a circuit-switched fallback procedure according to various aspects disclosed.

FIG. 5 is a flow diagram illustrating a method for a circuit-switched fallback procedure according to various aspects disclosed.

FIG. 6 is a schematic example of a wireless environment that can operate in accordance with aspects disclosed.

FIG. 7 is an illustration of an example wireless network platform to implement various aspects disclosed.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor, a process running on a processor, a controller, a circuit or a circuit element, an object, an executable, a program, a storage device, a computer, a tablet PC and/or a mobile phone with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components or elements without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

In consideration of the above described deficiencies of CSFB power control for network systems, various aspects are described for skipping the authentication procedure during CSFB in order to shorten the call setup time. By skipping the authentication procedure for a network device or User Equipment (UE) device during CSFB, the call setup time can be shorted to be around 1.5 seconds or less, and the overall CS call setup times can be shortened to be around 3 seconds or less, considering an end-to-end call comprising Mobile Origination (MO) and Mobile Terminating (MT) CSFB. For example, by adding approximately two additional steps in operational procedures between a Mobility Management Entity (MME) component and a Mobile Switching Center (MSC) component, the authentication procedure time can be eliminated. This can be performed, for example, without impacting operations of an E-UTRAN component of the network system.

In one example, a UE comprises a memory storing executable instructions and a processor, coupled to the memory, configured to execute the executable instructions. The processor executes the executable instructions to acquire or receive a Key Access security Management Entity (K_{ASME}), which forms the basis for generation of Access Stratum (AS) and Non-Access Stratum (NAS) cipher procedures involved in authentication processes between a user and a network device of the network system. The UE communicates an extended service request message to originate a CSFB procedure in an evolved packet system (EPS). In response to the communication or thereafter, the UE derives, or generates, one or more CS key parameters from the K_{ASME}. The CSFB procedure is further facilitated based on the CS key parameters derived from the K_{ASME}.

According to CSFB operations, in response to a UE tuning to 2G or 3G networks, the authentication procedure operates in order to generate the CS key parameters, such as a Cipher Key (CK), an Integrity Key (IK) for UMTS, a cipher key (Kc) for Global System for Mobile communications (GSM), and related Key Set Identifiers (KSIs), for example, in which such an authentication procedure can introduce longer CSFB call setup times. However, the authentication procedure can be avoided, as the subscriber has been authenticated at least once in EPS. The UE and the MME server component can store the K_{ASME}, which can be further used to derive the CS key parameters stored in UE and the MSC server component respectively. In one manner, an Ultra-flash CSFB solution can be made to skip the following steps:
(1) Skip authentication by reusing the CS key parameters for Single Radio Voice Call Continuity (SRVCC) processes;
(2) Skip CS bearer assignment by assuming the CSFB is triggered for voice calls; or
(3) Skip a Location Area Update (LAU) by using a target Base Station Controller (BSC)/NodeB identification (ID) to choose the accurate MSC/Location Area Identity (LAI).

Regarding bullet (2), CSFB can be triggered for other CS services such as Location Services (LCS), Unstructured Supplementary Service Data (USSD) and video, in which assuming that CSFB is always triggered for voice call is incorrect, possibly resulting in a wrong CS bearer assignment. Regarding bullet (3), a LAU is used after CSFB only when the MSC/LAI is changed. Thus, for some cases, in which the MSC/LAI is not changed, there is not much benefit from LAU, whether LAU is used after CSFB is also up to network deployment. Therefore, if only for the purpose of skipping authentication, CSFB processes do not have to trigger the entire SRVCC procedure and impact eNB (eNB determines whether to initiate SRVCC under the situation of no QoS Class Identifier (QCI)=1 bearer for the UE). As such, solutions involving (2) and (3) above are problematic. Additional aspects and details of the disclosure are further described below with reference to figures.

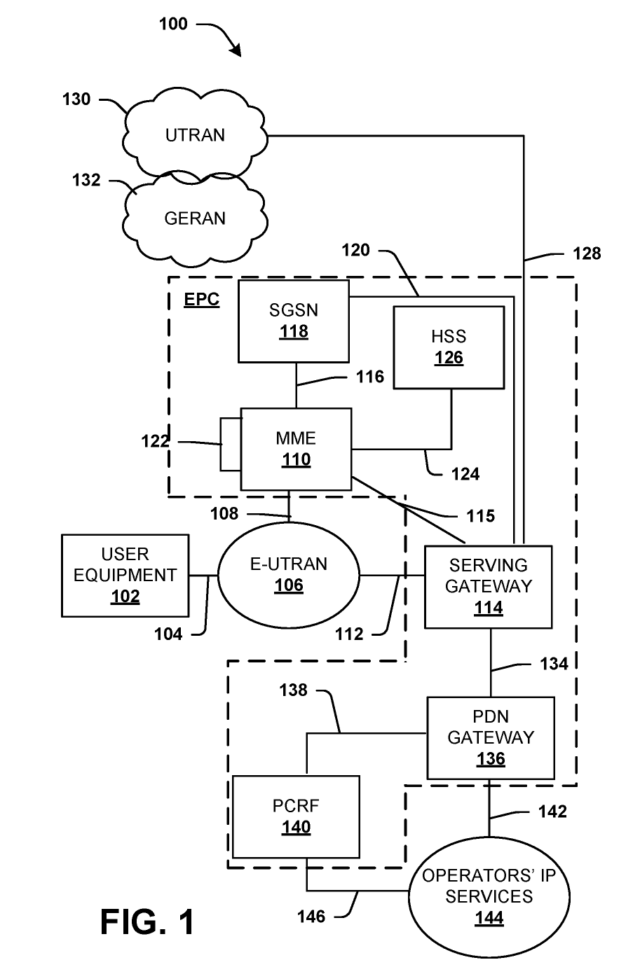

Referring to FIG. 1, illustrated is an example of a mobile network communication system in accordance with various aspects being described. In various examples, a mobile network 100 is an evolved packet core (EPC) network supporting, without limitation, GERAN, UTRAN, and/or E-UTRAN. UE 102 (Mobile Station (MS)) is communicatively coupled via a radio interface 104 (e.g., LTE-Uu) to an E-UTRAN 106 system. The E-UTRAN 106 can be communicatively coupled via a S1-MME (Mobility Management Entity) link 108 to a MME 110 and via a S1-U link 112 to a Serving Gateway 114. The MME 110 can be directly connected to the Serving Gateway 114 via an S11 link 115 and can be connected via a S3 link 116 to a Serving General Packet Radio Subsystem Support Node (SGSN) 118, which is itself connected via an S4 link 120 to the Serving Gateway 114. The MME 110 can include an internal S10 link 122 and an Sha link 124 to a High Speed Serial (HSS) interface node 126.

The Serving Gateway 114 may be connected via an S12 link 128 to one or more UTRAN 130 and GERAN 132 networks. The Serving Gateway 114 may further be connected via an S5 link 134 to a public data network (PDN) gateway 136. The PDN gateway 136 may be connected via a link 138 to a policy and changing rules function (PCRF) node 140 and via a SGi link 142 to an operator's IP services 144, such as an IP Multimedia Subsystem (IMS). The PCRF node 140 may be connected to the operator's IP services 144 via a link 146.

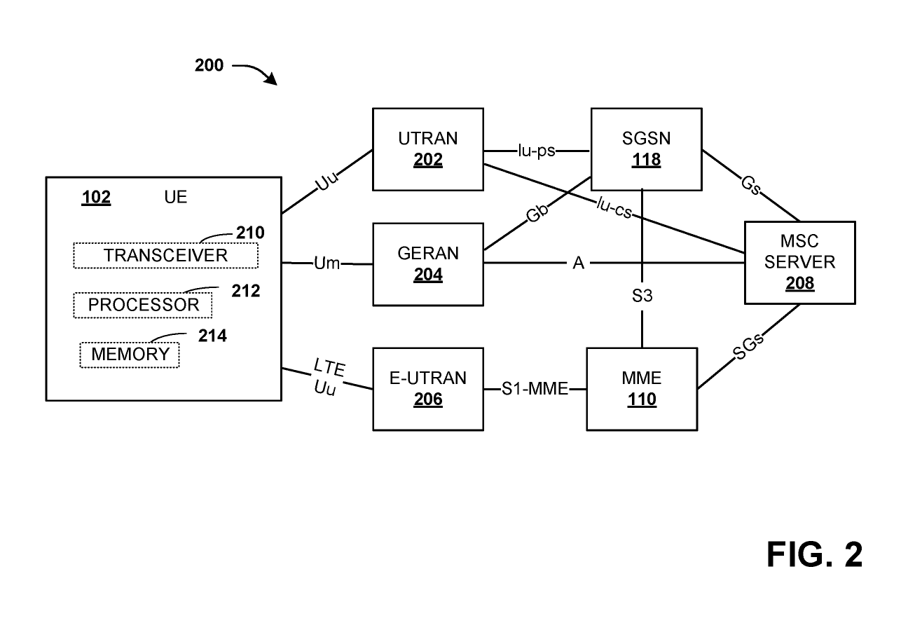

FIG. 2 is a block diagram of a mobile network architecture 200 for circuit-switched fallback (CSFB), in an example embodiment. The architecture 200 may operate with respect to the mobile network 100 or any suitable mobile network, for example.

The UE 102 is communicatively coupled or selectively coupled to a UTRAN cell 202, a GERAN cell 204, and an E-UTRAN cell 206. The UTRAN cell 202 and the GERAN cell 204 are coupled or selectively coupled to the SGSN 118 and mobile switching center (MSC) server 208. The E-UTRAN cell 206 is coupled or selectively coupled to the MME 110. The MME 110 is coupled or selectively coupled to the SGSN 118 and the MSC server 208.

The GERAN 132 and UTRAN 130 RANs can be connected to a circuit-switched (CS) domain of the network 100, such as embodied in the architecture 200. For instances in which the UE 102 is operating in or is communicating via the E-UTRAN 206 cell when the subscriber wants to setup a CS voice call, the mobile network 100 can generate a CSFB procedure. In CSFB, the UE 102 in the E-UTRAN 206 cell can signal to the core network 100 a request to set up a CS call or the UE 102 can respond to a paging for a CS call, for example. The mobile network 100 and/or the architecture 200 can operate to redirect the UE 102 to a GERAN 204 or UTRAN 202 cell, such as via a packet-switched (PS) handover, via a “release with redirection” procedure, or via a network-assisted cell change over (CCO), for example. In such examples, the UE 102 can set up the mobile originating call or receive the mobile terminating call via the MSC server 208. Once the CS call is released in GERAN 204 and/or UTRAN 202 cells, the UE 102 can then return to the E-UTRAN cell 206 either on its own (e.g., via cell re-selection) or with the help of the GERAN and/or UTRAN (e.g., if, during the release of the radio connection for the CS call the GERAN 204 and/or UTRAN 202 cells commands the UE 102 to immediately select a specific E-UTRAN cell 206).

During the CS call, if the UE 102 is in a GERAN cell 204 and the UE 102 or the GERAN cell 204 is not supporting the simultaneous use of CS services and packet services (e.g., because a dual transfer mode (DTM) feature is not present or not supported), then the network 100 and/or the architecture 200 can suspend packets services for the UE 102. In such a circumstance, downlink packets may not be delivered to the UE 102, but can be forwarded by a packet data network gateway (PDN-GW) toward the UE 102, potentially unnecessarily consuming network 100 and/or architecture 200 resources. In an example, the UE 102 or one of the core network nodes (e.g., the MME 110 and/or the SGSN 118, as appropriate) can inform a serving gateway (S-GW) or the PDN-GW that the gateways should no longer forward downlink user packets from the UE 102. Additionally or alternatively, the MME 110 or SGSN 118 can deactivate dedicated packet bearers, which are used for real-time services. Such services can demand that user data packets are delivered within a relatively short time.

The UE 102 includes a wireless transceiver 210, a processor 212, and electronic memory 214 including a register. The transceiver 210 is configured to communicate with the UTRAN cell 202, the GERAN cell 204, and the E-UTRAN cell 206. The processor 212 is configured to control, at least in part, an operation of the UE 102 generally and the components 210, 214 thereof. The processor 212 can be a microprocessor, a controller, or other dedicated hardware, as known in the art. The electronic memory 214 can be or include registers implemented according to any of a variety of electronic memory or other technologies suitable for implementing data registers known in the art.

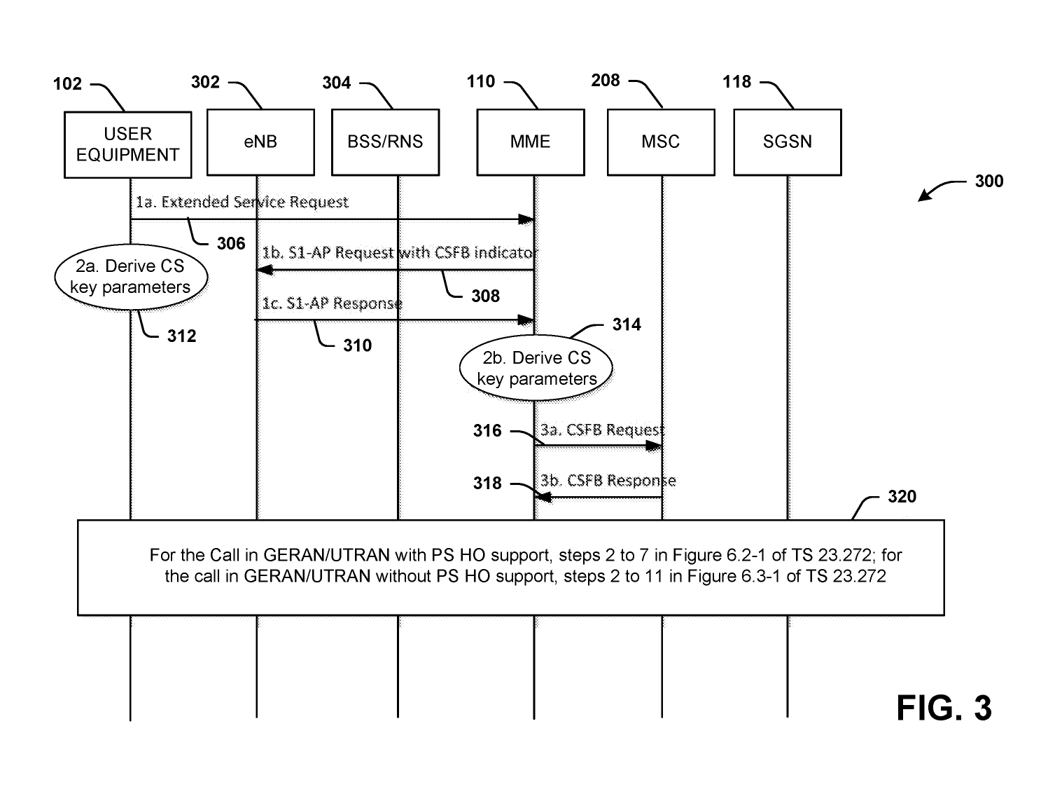

Referring to FIG. 3, illustrated is a scheme or data flow 300 for a CSFB procedure 300 that reduces call setup time in accordance with various aspects being described. The data flow 300 illustrates a method for providing voice services with LTE utilizing CSFB, which can be supported by SRVCC. The data flow 300 illustrates an enhanced CSFB procedure 300 to skip authentication in CSFB, in particular when the UE tunes to GERAN/UTRAN for mobile originating, for example. To enable CSFB, the MME component 110 connects to the MSC server component 208 via a server gateway's interface that enables the UE 102 to be both circuit-switched network and packet-switched network registered, which further enables a fallback from the LTE network (e.g., E-UTRAN 206) to a CS network (e.g., UTRAN 202, GERAN 204) in response to, or for, a mobile call. As such, the data flow 300 can operate for CSFB to enable the fallback from the LTE network to a CS network, for example, in response to a mobile originating call.

Referring to FIGS. 1, 2 and 3 together, at 306 the UE device 102 initiates a CSFB procedure to originate a mobile call by communicating an extended service request, or other service request. The UE device 102 provides, for example, the extended service request to the MME 110, such as via an S1-MME interface from the E-UTRAN 206 as shown in FIG. 2 (see, e.g., TS 23.272, sub-clause 6.2). The extended service request 306 can be encapsulated in a radio resource control (RRC) or S1-AP messages via the interface between MME and an eNodeB 302, or basestation (e.g., eNB). The UE 102 can transmit the extended service request when attached in the CS domain (with a combined EPS/international mobile subscriber identity (IMSI) Attach) and does not initiate an IMS voice session because the UE device 102 is not IMS registered or IMS voice services are not supported by the serving IP connectivity access network (IP-CAN), home PLMN or UE 102. The IMSI can be stored, for example, by a subscriber identity module (SIM) in a circuit, component or device with a related key used to identify or authenticate the subscriber or UE, for example.

At 308, the MME component 110 communicates an S1-AP UE context codification request (CSFB indicator, LAI) message to the eNB 302 in response to the extended service 306 request being communicated or received. This S1-AP UE context codification request message indicates to the eNB 302 that the UE device 102 should be moved to the UTRAN 202 or the GERAN network configured by a network device. The registered PLMN for CS domain connections is identified by a PLMN ID included in the LAI, which is allocated by the MME component 110.

In response to the MME component 110 determining that a CSFB procedure has priority handling based on a multimedia priority service (MPS) CS priority in the UE device's 102 EPS subscription or because there is an existing emergency call, the MME component 110 can set a priority indication, such as a CSFB High Priority, in the S1-AP message 308 to the eNB 302 (see, e.g., TS 36.413). In the case of an emergency call, the MME component 110 can also request that the eNB 302 inhibit roaming and access restrictions via an Additional CS Fallback Indicator 308 (see, e.g., TS 36.413). At 310, the eNB 302 replies in response to the S1-AP Request with CSFB indicator with an S1-AP response, such as an S1-AP UE Context Modification Response message as illustrated in FIG. 3.

At 312, the UE device 102 operates to derive CS key parameters for the CSFB procedure 300 from key access security management entity (K_{ASME}). For example, the key parameters can include a Cipher Key (CK), an Integrity Key (IK) for UMTS, a cipher key (Kc) for GSM, or related Key Set Identifiers (KSIs). In addition, the UE device 102 can receive or store the K_{ASME} from a result of an authentication in EPS previously, thereby avoiding an authentication process for CSFB. The K_{ASME}, for example, can be stored in the UE device 102, the MME component 110 or other component of the network systems described herein.

In one aspect, the UE device 102 (or a mobile equipment device) further operates to utilize the CK_{CSFB} or the IK_{CSFB}, which comprise the CK and IK derived for CSFB, by generating a global system for mobile communications circuit switched cipher key (GSM CS Kc), which can be a 64 bit or other bit number (e.g., 128 bit) ciphering key. The UE device 102, for example, can derive the GSM CS Kc based on at least one CS key parameter of the key parameters, such as the CK and the IK (the CK_{CSFB} and the IK_{CSFB}, as derived from K_{ASME} specifically for the CSFB procedure). A GSM cipher Kc, for example, can be utilized as a part of the GSM security context data, which is a state that is established between a user (UE device) and a serving network domain, such as via execution of a GSM authentication and key agreement procedure (GSM AKA). The GSM security context data, for example, can be stored at both ends of the UE device 102 and a network component or device, which can comprise at least one of the GSM cipher key Kc and the cipher key sequence number (CKSN).

In another aspect, the UE device 102 is configured to generate or derive the GSM CS Kc via a predetermined function based on the CS key parameters. For example, the GSM CS Kc can be generated with a c3 function (see, e.g., TS 33.102). The UE device 102 is further configured to assign a KSI (e.g., an extended KSI (eKSI), or other KSI) value associated with the plurality of CS key parameters to a GSM CS cipher key sequence number (GSM CS CKSN), which can be associated with or correspond to the GSM CS Kc. In one example, a CKSN (e.g., GSM CS CKSN) can be utilized in key management in a GSM system or other network system as a means to ensure cipher key consistency or to be able to refer to various encryption keys or cipher keys that are generated in the network. The UE device 102 can then further update its memory and a universal subscriber identity module (USIM) with the GSM CS Kc that is derived from a conversion function based on the CS key parameters. In addition, the UE device 102 can further update its memory and the USIM with the GSM CS CKSN.

At 314, the MME component 110 is configured to operate along similar processes and functions as the UE device 102 at 312. In addition or alternatively, other components, or network devices (e.g., the MSC component 208) of a communication network can also be configured to operate in a similar manner. Although the data flow diagram at 314 is illustrated as being subsequent to the process at 308 and 310, and the acts here are described as a series of acts or events, it will be appreciated that the illustrated ordering of such acts or events are not to be interpreted in a limiting sense. For example, the processes at 314 or at other operations (e.g., at 312) of the data flow 300 can come at other sequences or stages of the data flow 300, for example.

In another aspect, in response to receiving the extended service request message from the UE device 102 at 306, the MME component 110 is configured to generate the CS key parameters from the K_{ASME} stored or received on a network device or thereat. As stated above, these key parameters can include the CK, the IK with a KSI. The MME component 110 can also operate to utilize the CK_{CSFB} or the IK_{CSFB}, the CK, IK or KSI to be utilized for CSFB, by generating a global system for mobile communications circuit switched cipher key Kc (GSM CS Kc), which can be a 64 bit or other bit number (e.g., 128 bit) ciphering key. The MME component 110 can derive the GSM CS Kc based on one or more CS key parameters. The GSM cipher Kc or additional one specific to the MME component 110, for example, can be utilized as a part of the GSM security context data.

In another aspect, the MME component 110 is configured to generate or derive the GSM CS Kc via a predetermined function based on the CS key parameters. For example, the GSM CS Kc can be generated with the c3 function (see, e.g., TS 33.102). The MME component 110 can also be further configured to assign a KSI (e.g., an extended KSI (eKSI), or other KSI) value associated with the plurality of CS key parameters to the GSM CS CKSN, which can be associated with or correspond to the GSM CS Kc.

At 316, the MME component 110 can response to the extended service request at 306, the S1-AP response at 310, or the derivation of CS key parameters at 312 or 314, for example, to communicate a CSFB request to facilitate the CSFB procedure 300 to the MSC server component 208 via an Sv interface, for example. The MSC server component 208 is configured to further communicate a CSFB response at 318 to the MME component 110, such as a message indicating or confirming a CSFB status or other response, for example.

In another aspect, in response to the CSFB being from the E-UTRAN 206 to a GERAN 204, for example, the above aspects and functions described to FIG. 3 can also apply to the MME component 110, the enhanced MSC server component 208 and the UE device 102. As such, the enhanced MSC server component 208, for example, is configured to derive the CS key parameters from the K_{ASME} and also derive the GSM CS cipher key Kc or GSM CS Kc from CK_{CSFB} or the IK_{CSFB} with a predetermined function such as a key conversion function c3 (see, e.g., TS 33.102 for c3 function). The MSC server component 208 can further assign the value of eKSI, for example, or other KSI to the GSM CS CKSN that is associated with the GSM CS Kc. The target MSC server component 208, for example, and the UE device 102 can further compute a 128-bit GSM CS cipher key Kc₁₂₈ (GSM CS Kc₁₂₈) (see, e.g., TS 33.102) in response to an encryption algorithm being selected by the target base station (e.g., BSS/RNS 304) or the target base stations 304 requesting or requiring the 128-bit GSM CS cipher key Kc₁₂₈. The UE device 102 and the MSC server component 208 can then assign the value of the KSI or eKSI to the GSM CS CKSN that is associated with the GSM CS Kc₁₂₈.

In another aspect, the CS key parameters or key derivations for CSFB can have a PO that is a NAS uplink COUNT value and L0 can be equal to the length of the NAS uplink COUNT value, while Fc can be one of the reserved/unused values (0x1C-0x1F) (see, e.g., TS 33.401, annex A. 12/A.13). A key derivation function (KDF) can be used for a predetermined function herein, which is defined in clause A.7 of TS 33.401 and Annex B of TS 33.220, for example.

In another aspect, in cases where SRVCC is triggered by CSFB, the CS key parameters for SRVCC can be utilized, which means that CK_{SRVCC} or the IK_{SRVCC} can be used to replace CK_{CSFB} or the IK_{CSFB} for the CSFB procedure 300, for example. Therefore, in response to a SRVCC scheme being active concurrent with, or after, a reception of, or a communication of the extended service request message to originate the CSFB procedure, the components or devices being described (e.g., the UE device 102, the MME component 110, the MSC server component 208, or the like) can utilize the plurality of CS key parameters with a plurality of SRVCC key parameters to facilitate the CSFB processes further.

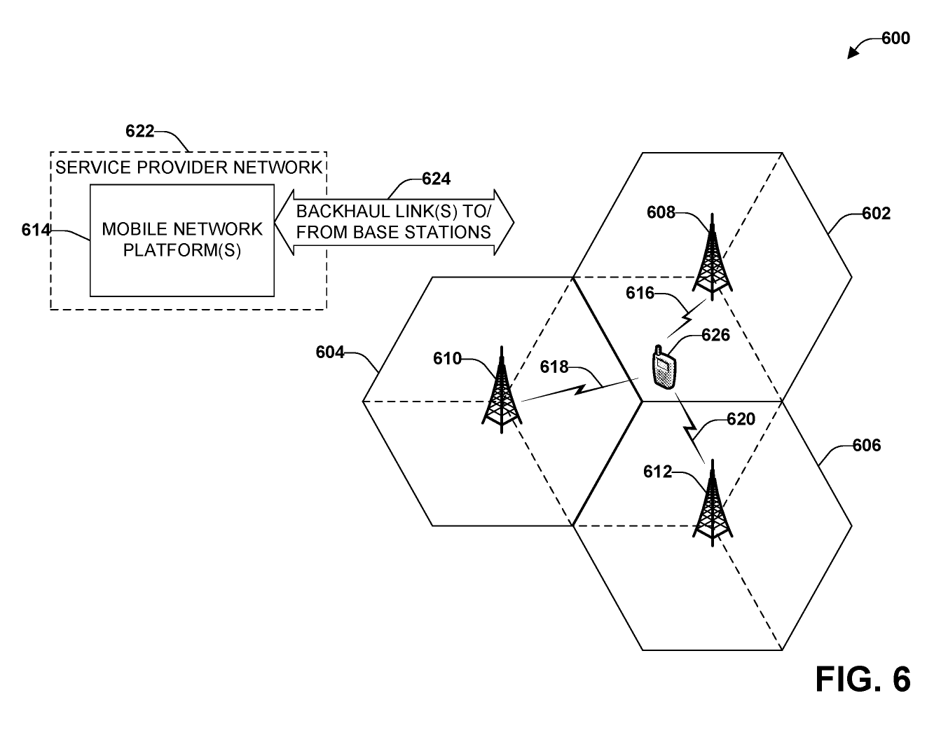

At 320 of FIG. 3, the CSFB procedure 300 further operates according to further operations based on whether an originating call in GERAN/UTRAN is with or without packet service handover (PS HO) support. In response to the call with PS HO, then the process proceeds according to 2-7 of Figure 6.2-1 of TS 23.272, for example. If the call is without PS HO, then steps 2-7 can proceed as in Figure 6.3-1 of TS 23.272, for example. As a result of the above processes however, at 312 or 314, a separate authentication of the UE device or a network device/component (e.g., MME or MSC) can be avoided.

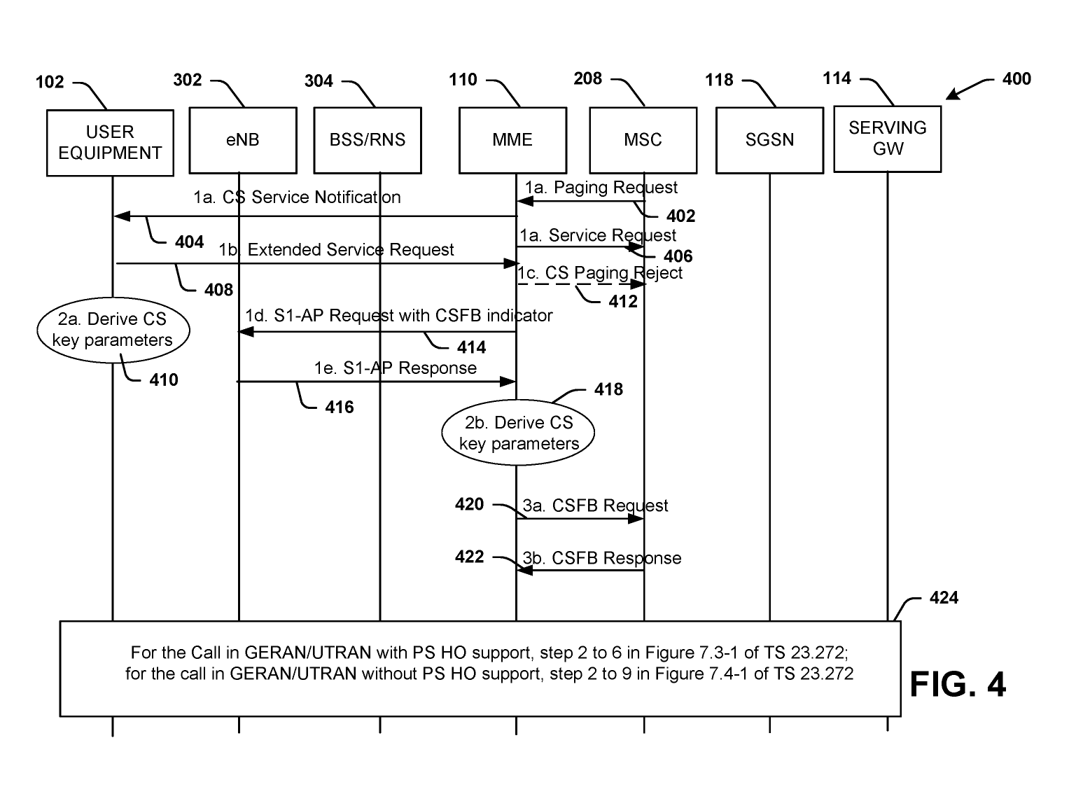

Referring now to FIG. 4, illustrated is an enhanced CSFB procedure to further skip one or more authentication processes when the UE 102 tunes to GERAN/UTRAN for a mobile terminating procedure.

At 402, the MSC server component 208 can receive an incoming voice call and responds by sending a Paging Request (e.g., via IMSI or TMSI, optional caller line identification and connection management information, CS call indicator, priority indication) to the MME component 110 over an SG interface. The MSC server component 308, for example, communicates a CS Page for a UE device (e.g., UE device 102) that provides location update information using the SG interface. In an active mode, the MME component 110 has an established S1 connection, and in response to the MME component 110 not having returned an “SMS-only” indication to the UE device 102 during attach or combined TA/LA update procedures, the MME component 110 can reuse the existing connection to relay the CS page to the UE device 102, such as in a CS service notification at 404. However, in response to the MME component 110 having returned the “SMS-only” indication to the UE device 102 during attach or combined TA/LA update procedures, the MME component 110 will refrain from sending the CS Service Notification, at 404, to the UE device 102 and, at 412, sends a paging reject message or notification towards the MSC server component 208 to stop CS Paging procedure, in which the CSFB procedure stops.

The eNB 302 forwards the paging message to the UE device 102. The message comprises a CN Domain indicator (indicating the domain that initiated paging), and, if received from the MSC server component 208, the caller line identification.

At 406, the MME component 110 then sends the SGs Service Request message to the MSC server component 208 comprising an indication that the UE device 102 was in a connected mode. The MSC server component 208 uses this connected mode indication to start the call forwarding on no reply timer for the UE device 102 and the MSC server component 208 sends an indication of user alerting to the calling party. Receipt of the SGs service request message at 406 stops the MSC server component 208 from retransmitting the SGs interface paging message.

In one note, a pre-configured policy can be used by the UE device 102 to avoid being disturbed without a caller line identification display and the detailed handling can be decided by class type (CT) aspects of voice handling such as CT1 and CT6. In addition, this above process can also take place immediately after the MSC server component 208 receives a MAP_PRN from the HSS 126, if pre-paging is deployed. Caller line identification and the CS call indicator can also be provided in the case of pre-paging. Further, in order to avoid the calling party experiencing a potentially long period of silence or wait, the MSC server component 208 can use the SGs service request message, at 406, as a trigger to inform the calling party that the call is progressing. If the MME component 110 receives a paging request message with a priority indication, e.g. eMLPP priority, from the MSC server component 208, then the MME component 110 processes this message and also the subsequent CSFB procedure preferentially compared to other normal procedures.

At 408, the UE device 102 sends an extended service request at 408 (as a Reject or an Accept) message to the MME component 110 for mobile terminating CSFB procedure. The extended service request message can be encapsulated in RRC and S1-AP messages. The UE device 102 can then decide to reject CSFB based on a caller line identification.

At 412, in response to receiving the extended service request at 408 as a Reject for a mobile terminating CSFB procedure, the MME component 110 sends a CS paging reject towards the MSC server component 208 to stop a CS paging procedure and the current CSFB procedure stops.

At 414, the MME component 110 sends an S1-AP UE context modification request (with a CSFB indicator, LAI) message to the eNB device 302. This message indicates to the eNB device 302 that the UE device 102 should be moved to a UTRAN/GERAN network. The registered PLMN for CS domain is identified by the PLMN ID included in the LAI, which is allocated by the MME component 110. If the MME component 110 received a priority indication at part of step 1a at 402 thru 408, the MME component 110 sends the S1-AP request as the S1-AP UE context modification request message to the eNB 302 with a priority indication, i.e. “CSFB High Priority” (see, e.g., TS 36.413).

At 416, the eNB device 302 replies with an S1-AP response such as an S1-AP UE context modification response message to the MME component 110, for example.

At 410, the UE device 102 can generate or derive one or more CS key parameters for CSFB from K_{ASME}. The derivation of one or more CS key parameters for a CSFB procedure can occur at any point, act or stage during or after the extended service request is communicated at 408 by the UE device 102, for example. The UE or ME device 102 can use the CK_{CSFB} and IK_{CSFB} to derive the GSM CS Kc using the c3 function as a predetermined conversion function (see, e.g., TS 33.102). The UE device 102 can assign an eKSI value (e.g., as associated with CK_{CSFB} and IK_{CSFB}) to the GSM CS CKSN (associated with the GSM CS Kc). The UE device 102 can further update the USIM and the UE 102 with the GSM CS Kc and GSM CS CKSN.\

At 418, the MME component 110 can also derive one or more CS key parameters for CSFB from K_{ASME}. At 420, the MME component 110 sends a CSFB request message to the MSC server component 208 including the derived CS key parameters for CSFB. At 422, the MSC server component 208 stores the CS key parameters for CSFB, and sends a CSFB response message to the MME component 110. If the target network is a GERAN network 132, 204 of a network device, the enhanced MSC server component 208 can, in addition, derive GSM CS cipher key Kc from CK_{CSFB} and IK_{CSFB} with the help of the key conversion function c3 (see, e.g., TS 33.102), and assign the value of eKSI to GSM CS CKSN associated with the GSM CS Kc.

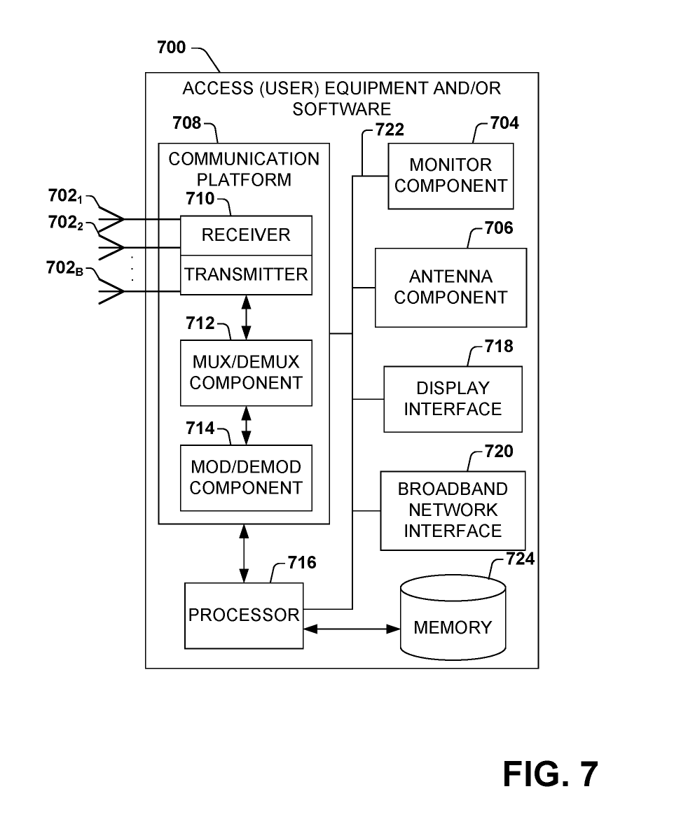

The procedure continues at 424 depending on whether PS HO support exists or not. For the call in GERAN/UTRAN with PS HO support, the CSFB procedure proceeds in a similar way with acts 2 to 6 in Figure 7.3-1 of TS 23.272. For the call in GERAN/UTRAN without PS HO support, the CSFB procedure proceeds in a similar way with acts 2 to 9 in Figure 7.4-1 of TS 23.272. In another aspect, in response to SRVCC being triggered or operational by CSFB, the CS key parameters for SRVCC can be used, which means the CK_{SRCCC} and IK_{SRVCC} can be used to replace the aforementioned CK_{CSFB} and IK_{CSFB} respectively.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

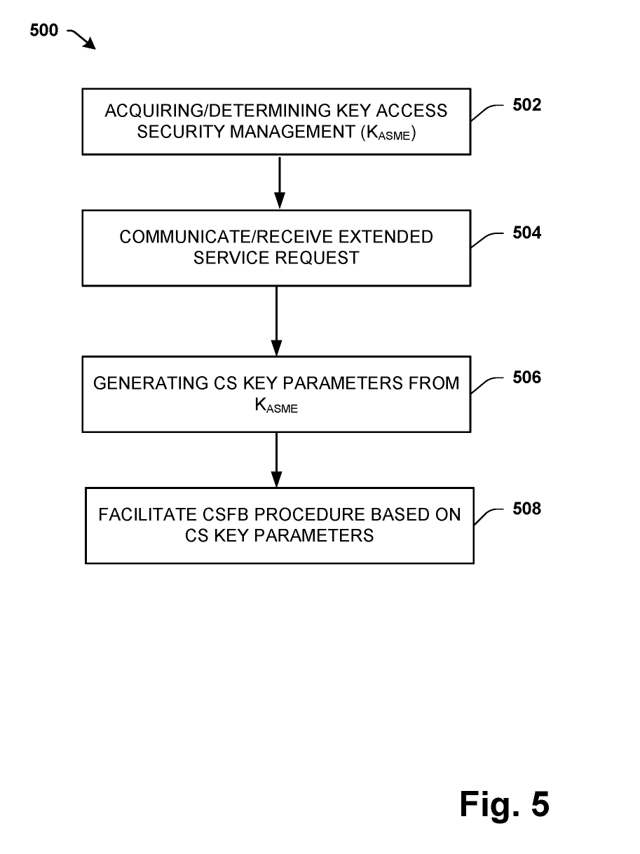

Referring to FIG. 5, illustrated is an example method 500 for shortening call setup time by skipping an authentication procedure according to various aspects. The method 500 initiates at 502 with acquiring the K_{ASME}. For example, the K_{ASME} can be received from the HSS 126 or other network component. At 504, the method comprises communicating an extended service request message to originate a CSFB procedure in an EPS, such as from the UE to the MME. At 506, the method comprises generating a plurality of CS key parameters from the K_{ASME}, such as at the UE, MME or MSC. For example, the plurality of CS key parameters can comprise a cipher key (Kc) and an integrity key (IK) with a KSI or KSI value for the CSFB procedure. The derivation process can be initiated in response to the extended service request being received, or communicated, for example, as a trigger for generation, either immediately or at a subsequent process stage. Additionally, the CS key parameters can be derived after an origination of the CSFB procedure independent of an additional authentication operation thereafter.

At 508, facilitate or further the CSFB procedure based on the set of CS key parameters generated or derived from the K_{ASME}.

In other aspects, the method can include generating a GSM CS Kc based on at least one CS key parameter of the plurality of CS key parameters. A KSI (e.g., an eKSI) that is associated with or corresponds to one or more of the CS key parameters can be to the GSM CS CKSN. The universal subscriber identity module (USIM) can then be updated with the GSM CS Kc as it is derived from a predetermined conversion function based on CS key parameters.

In response to a SRVCC scheme being active concurrent to, or after, a communication of the extended service request message to originate the CSFB procedure, the method 500 can further comprise replacing the CS key parameters with SRVCC key parameters for the CSFB procedure following.

The acts of the methods can operate CSFB between one or more network components or devices. For example, a first network device or component can comprise an E-UTRAN network device configured to generate the first network as an E-UTRAN, and a second network device can comprises a GERAN device, or a UTRAN device, which can generate the second network as a GERAN or a UTRAN, respectively.

In one example, an MSC server component (e.g., MSC server component 208) can be communicatively coupled to a UE device 102, wherein the MSC server component 208 and the UE device 102 can operate to generate a GSM CS Kc based on at least one CS key parameter, determine a KSI (e.g., eKSI) value based on the plurality of CS key parameters, and assign the KSI value associated with the plurality of CS key parameters to a GSM CS cipher key sequence number (GSM CS CKSN) associated with the GSM CS Kc.

The MSC server component 208 and the UE device 102, as well as the MME component 110 are further configured to determine a 128-bit GSM cipher key (Kc₁₂₈) based on the plurality of CS key parameters, such as when response to a SRVCC scheme or process is active. The MSC server component and the UE device are further configured to assign the KSI value associated with the plurality of CS key parameters to the GSM CS CKSN based on the Kc₁₂₈. The MSC server component 208 can determine a 128-bit GSM cipher key (Kc₁₂₈) based on the plurality of CS key parameters and then communicate the Kc₁₂₈ to the second network device (in response to a selection of an encryption process by the second network device, or a target eNB 302, for example.

By way of further description with respect to one or more non-limiting environments that facilitate CSFB according to the aspects and embodiments being described herein, FIG. 6 is a schematic example wireless environment 600. In particular, the example wireless environment 600 illustrates a set of wireless network macro cells. Three coverage macro cells 602, 604, and 606 include the illustrative wireless environment; however, it is noted that wireless cellular network deployments can encompass any number of macro cells. Coverage macro cells 602, 604, and 606 are illustrated as hexagons; however, coverage cells can adopt other geometries generally dictated by a deployment configuration or floor plan, geographic areas to be covered, and so on. Each macro cell 602, 604, and 606 is sectorized in a 27/3 configuration in which each macro cell includes three sectors, demarcated with dashed lines in FIG. 6. It is noted that other sectorizations are possible, and aspects or features of the disclosed subject matter can be exploited regardless of type of sectorization. Macro cells 602, 604, and 606 are served respectively through base stations or eNodeBs 608, 610, and 612. Any two eNodeBs can be considered an eNodeB site pair. It is noted that radio component(s) are functionally coupled through links such as cables (e.g., RF and microwave coaxial lines), ports, switches, connectors, and the like, to a set of one or more antennas that transmit and receive wireless signals (not illustrated). It is noted that a radio network controller (not shown), which can be a part of mobile network platform(s) 614, and set of base stations (e.g., eNode B 608, 610, and 612) that serve a set of macro cells; electronic circuitry or components associated with the base stations in the set of base stations; a set of respective wireless links (e.g., links 616, 618, and 620) operated in accordance with a radio technology through the base stations, form a macro radio access network. It is further noted that, based on network features, the radio controller can be distributed among the set of base stations or associated radio equipment. In an aspect, for universal mobile telecommunication system-based networks, wireless links 616, 618, and 620 embody a Uu interface (universal mobile telecommunication system Air Interface).

Mobile network platform(s) 614 facilitates circuit switched-based (e.g., voice and data) and packet-switched (e.g., Internet protocol, frame relay, or asynchronous transfer mode) traffic and signaling generation, as well as delivery and reception for networked telecommunication, in accordance with various radio technologies for disparate markets. Telecommunication is based at least in part on standardized protocols for communication determined by a radio technology utilized for communication. In addition, telecommunication can exploit various frequency bands, or carriers, which include any electromagnetic frequency bands licensed by the service provider network 622 (e.g., personal communication services, advanced wireless services, general wireless communications service, and so forth), and any unlicensed frequency bands currently available for telecommunication. In addition, mobile network platform(s) 614 can control and manage base stations 608, 610, and 612 and radio component(s) associated thereof, in disparate macro cells 602, 604, and 606 by way of, for example, a wireless network management component (e.g., radio network controller(s), cellular gateway node(s), etc.). Moreover, wireless network platform(s) can integrate disparate networks (e.g., Wi-Fi network(s), femto cell network(s), broadband network(s), service network(s), enterprise network(s), and so on). In cellular wireless technologies (e.g., third generation partnership project universal mobile telecommunication system, global system for mobile communication, etc.), mobile network platform 614 can be embodied in the service provider network 622.

In addition, wireless backhaul link(s) 624 can include wired link components such as a T1/E1 phone line, a T3/DS3 line, a digital subscriber line either synchronous or asynchronous; an asymmetric digital subscriber line; an optical fiber backbone; a coaxial cable, etc.; and wireless link components such as line-of-sight or non-line-of-sight links which can include terrestrial air-interfaces or deep space links (e.g., satellite communication links for navigation). In an aspect, for universal mobile telecommunication system-based networks, wireless backhaul link(s) 624 embodies an IuB interface.

It is noted that while an exemplary wireless environment 600 is illustrated for macro cells and macro base stations, aspects, features and advantages of the disclosed subject matter can be implemented in micro cells, pico cells, femto cells, or the like, wherein base stations are embodied in home-based equipment related to access to a network.

To provide further context for various aspects of the disclosed subject matter, FIG. 7 illustrates a block diagram of an embodiment of access equipment and/or software 700 related to access of a network (e.g., base station, wireless access point, femtocell access point, and so forth) that can enable and/or exploit features or aspects disclosed herein.

Access equipment, UE and/or software 700 related to access of a network can receive and transmit signal(s) from and to wireless devices, wireless ports, wireless routers, etc. through segments 702₁-702_{B} (B is a positive integer). Segments 702₁-702_{B} can be internal and/or external to access equipment and/or software 700 related to access of a network, and can be controlled by a monitor component 704 and an antenna component 706. Monitor component 704 and antenna component 706 can couple to communication platform 708, which can include electronic components and associated circuitry that provide for processing and manipulation of received signal(s) and other signal(s) to be transmitted.

In an aspect, communication platform 708 includes a receiver/transmitter 710 that can convert analog signals to digital signals upon reception of the analog signals, and can convert digital signals to analog signals upon transmission. In addition, receiver/transmitter 710 can divide a single data stream into multiple, parallel data streams, or perform the reciprocal operation. Coupled to receiver/transmitter 710 can be a multiplexer/demultiplexer 712 that can facilitate manipulation of signals in time and frequency space. Multiplexer/demultiplexer 712 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 712 can scramble and spread information (e.g., codes, according to substantially any code known in the art, such as Hadamard-Walsh codes, Baker codes, Kasami codes, polyphase codes, and so forth).

A modulator/demodulator 714 is also a part of communication platform 708, and can modulate information according to multiple modulation techniques, such as frequency modulation, amplitude modulation (e.g., M-ary quadrature amplitude modulation, with M a positive integer); phase-shift keying; and so forth).

Access equipment and/or software 700 related to access of a network also includes a processor 716 configured to confer, at least in part, functionality to substantially any electronic component in access equipment and/or software 700. In particular, processor 716 can facilitate configuration of access equipment and/or software 700 through, for example, monitor component 704, antenna component 706, and one or more components therein. Additionally, access equipment and/or software 700 can include display interface 718, which can display functions that control functionality of access equipment and/or software 700, or reveal operation conditions thereof. In addition, display interface 718 can include a screen to convey information to an end user. In an aspect, display interface 718 can be a liquid crystal display, a plasma panel, a monolithic thin-film based electrochromic display, and so on. Moreover, display interface 718 can include a component (e.g., speaker) that facilitates communication of aural indicia, which can also be employed in connection with messages that convey operational instructions to an end user. Display interface 718 can also facilitate data entry (e.g., through a linked keypad or through touch gestures), which can cause access equipment and/or software 700 to receive external commands (e.g., restart operation).

Broadband network interface 720 facilitates connection of access equipment and/or software 700 to a service provider network (not shown) that can include one or more cellular technologies (e.g., third generation partnership project universal mobile telecommunication system, global system for mobile communication, and so on) through backhaul link(s) (not shown), which enable incoming and outgoing data flow. Broadband network interface 720 can be internal or external to access equipment and/or software 700, and can utilize display interface 718 for end-user interaction and status information delivery.

Processor 716 can be functionally connected to communication platform 708 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 716 can be functionally connected, through data, system, or an address bus 722, to display interface 718 and broadband network interface 720, to confer, at least in part, functionality to each of such components.

In access equipment and/or software 700, memory 724 can retain location and/or coverage area (e.g., macro sector, identifier(s)) access list(s) that authorize access to wireless coverage through access equipment and/or software 700, sector intelligence that can include ranking of coverage areas in the wireless environment of access equipment and/or software 700, radio link quality and strength associated therewith, or the like. Memory 724 also can store data structures, code instructions and program modules, system or device information, code sequences for scrambling, spreading and pilot transmission, access point configuration, and so on. Processor 716 can be coupled (e.g., through a memory bus), to memory 724 in order to store and retrieve information used to operate and/or confer functionality to the components, platform, and interface that reside within access equipment and/or software 700.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 1024, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is a user equipment (UE), comprising a memory storing executable instructions, and a processor, coupled to the memory. The processor is configured to execute the executable instructions to acquire a key access security management entity (K_{ASME}); communicate an extended service request message to originate a circuit switched fallback (CSFB) procedure in an evolved packet system (EPS); generate a plurality of circuit switched (CS) key parameters from the K_{ASME}; and facilitate the CSFB procedure based on the plurality of CS key parameters generated from the K_{ASME}.

Example 2 includes the subject matter of example 1, wherein the processor is further configured to execute the executable instructions to generate a global system for mobile communications circuit switched cipher key (GSM CS Kc) based on at least one CS key parameter of the plurality of CS key parameters.

Example 3 includes the subject matter of any of examples 1-2, including or omitting optional features, wherein the processor is further configured to execute the executable instructions to assign a key set identifier (KSI) value associated with the plurality of CS key parameters to a GSM CS cipher key sequence number (GSM CS CKSN).

Example 4 includes the subject matter of any of examples 1-3, including or omitting optional features, wherein the processor is further configured to execute the executable instructions to update a universal subscriber identity module (USIM) with a GSM CS Kc derived that is derived from a conversion function based on the plurality of CS key parameters.

Example 5 includes the subject matter of any of examples 1-4, including or omitting optional features, wherein the plurality of CS key parameters comprise a cipher key and an integrity key with a KSI for the CSFB procedure.

Example 6 includes the subject matter of any of examples 1-5, including or omitting optional features, wherein the processor is further configured to execute the executable instructions to, in response to a single radio voice call continuity (SRVCC) scheme being active concurrent to, or after, a communication of the extended service request message to originate the CSFB procedure, replacing the plurality of CS key parameters with a plurality of SRVCC key parameters.

Example 7 includes the subject matter of any of examples 1-6, including or omitting optional features, wherein the processor is further configured to execute the executable instructions to derive the plurality of CS key parameters after an origination of the CSFB procedure independent of an additional authentication operation.

Example 8 is a system for circuit switched fallback (CSFB) comprising a processing device, comprising a memory storing executable instructions. The processing device is configured to execute the executable instructions to at least determine a security key that enables an authorization or an authentication process; receive an extended service request message to originate a CSFB process from a first network of a first network device to a second network of a second network device in response to a mobile originating call or a mobile terminating call; generate a plurality of circuit switched (CS) key parameters from the security key; and facilitate the CSFB procedure based on the plurality of CS key parameters from the security key.

Example 9 includes the subject matter of any of examples 8, wherein the processing device is further configured to execute the executable instructions to generate a global system for mobile communications circuit switched cipher key (GSM CS Kc) via a conversion function based on the plurality of CS key parameters.

Example 10 includes the subject matter of any of examples 8-9, including or omitting optional features, wherein the processing device is further configured to execute the executable instructions to: communicate the plurality of CS key parameters to a mobile switching center (MSC) server component to facilitate the CSFB procedure based on the plurality of CS key parameters from the security key.

Example 11 includes the subject matter of any of examples 8-10, including or omitting optional features, wherein the first network device comprises an evolved-universal mobile telecommunications system terrestrial radio access network (E-UTRAN) device configured to generate the first network as an E-UTRAN, and the second network device comprises a General Packet Radio Subsystem Evolved Radio Access Network (GERAN) device, or a UTRAN device, configured to generate the second network as a GERAN or a UTRAN, respectively.

Example 12 includes the subject matter of any of examples 8-11, including or omitting optional features, further comprising an MSC server component communicatively coupled to a user equipment (UE) device, wherein the MSC server component and the UE device are configured to: generate a GSM CS Kc based on at least one CS key parameter of the plurality of CS key parameters; determine a key set identifier (KSI) value based on the plurality of CS key parameters; and assign the KSI value associated with the plurality of CS key parameters to a GSM CS cipher key sequence number (GSM CS CKSN) associated with the GSM CS Kc.

Example 13 includes the subject matter of any of examples 8-12, including or omitting optional features, wherein the first network device comprises an E-UTRAN device and the second network comprises a GERAN device.

Example 14 includes the subject matter of any of examples 8-13, including or omitting optional features, wherein the MSC server component and the UE device are further configured to determine a 128-bit GSM cipher key (Kc₁₂₈) based on the plurality of CS key parameters.

Example 15 includes the subject matter of any of examples 8-14, including or omitting optional features, wherein the MSC server component and the UE device are further configured to assign the KSI value associated with the plurality of CS key parameters to the GSM CS CKSN based on the Kc₁₂₈.

Example 16 includes the subject matter of any of examples 8-15, including or omitting optional features, further comprising: an MSC server component configured to determine a 128-bit GSM cipher key (Kc₁₂₈) based on the plurality of CS key parameters and communicate the Kc₁₂₈ to the second network device in response to a selection of an encryption process by the second network device.

Example 17 includes the subject matter of any of examples 8-16, including or omitting optional features, wherein the processing device is further configured to execute the executable instructions to, in response to a single radio voice call continuity (SRVCC) scheme being active concurrent with, or after, a reception of the extended service request message to originate the CSFB procedure, replacing the plurality of CS key parameters with a plurality of SRVCC key parameters.

Example 18 includes the subject matter of any of examples 8-17, including or omitting optional features, wherein the processing device is further configured to execute the executable instructions to: update a universal subscriber identity module (USIM) with a GSM CS Kc that is based on the plurality of CS key parameters.

Example 19 is a computer-readable storage device storing executable instructions that, in response to execution, cause a system comprising a processor to perform operations, comprising: deriving a plurality of circuit switched (CS) key parameters from a key access security management entity (K_{ASME}); communicating, or receiving, an extended service request message to originate a circuit switched fallback (CSFB) procedure and the plurality of CS key parameters; and facilitating the CSFB procedure based on the plurality of CS key parameters derived from the K_{ASME}.

Example 20 includes the subject matter of example 19, wherein the operations further comprise: generating a global system for mobile communications circuit switched cipher key (GSM CS Kc) based on at least one CS key parameter of the plurality of CS key parameters; determining a key set identifier (KSI) value based on the plurality of CS key parameters; and assigning the KSI value associated with the plurality of CS key parameters to a GSM CS cipher key sequence number (GSM CS CKSN) corresponding to the GSM CS Kc.

Example 21 includes the subject matter of any of examples 19-20, including or omitting optional features, wherein the operations further comprise, in response to a single radio voice call continuity (SRVCC) scheme being active concurrent with, or after, a reception of, or a communication of, the extended service request message to originate the CSFB procedure, replacing the plurality of CS key parameters with a plurality of SRVCC key parameters.

It is to be understood that aspects described herein can be implemented by hardware, software, firmware, or any combination thereof. When implemented in software, functions can be stored on or transmitted over as one or more instructions or code on a computer-readable medium. Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the s and/or actions described herein.

For a software implementation, techniques described herein can be implemented with modules (e.g., procedures, functions, and so on) that perform functions described herein. Software codes can be stored in memory units and executed by processors. Memory unit can be implemented within processor or external to processor, in which case memory unit can be communicatively coupled to processor through various means as is known in the art. Further, at least one processor can include one or more modules operable to perform functions described herein.

Techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), CDMA1800, etc. UTRA includes Wideband-CDMA (W-CDMA) and other variants of CDMA. Further, CDMA1800 covers IS-1800, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.18, Flash-OFDML, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA1800 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1. A user equipment (UE), comprising:
a memory storing executable instructions;
a processor, coupled to the memory, configured to execute the executable instructions to:
acquire a key access security management entity (K_{ASME});
communicate an extended service request message to originate a circuit switched fallback (CSFB) procedure in an evolved packet system (EPS);
generate a plurality of circuit switched (CS) key parameters from the K_{ASME}; and
facilitate the CSFB procedure based on the plurality of CS key parameters generated from the K_{ASME}.

2. The UE of claim 1, wherein the processor is further configured to execute the executable instructions to:
generate a global system for mobile communications circuit switched cipher key (GSM CS Kc) based on at least one CS key parameter of the plurality of CS key parameters.

3. The UE of claim 1, wherein the processor is further configured to execute the executable instructions to:
assign a key set identifier (KSI) value associated with the plurality of CS key parameters to a GSM CS cipher key sequence number (GSM CS CKSN).

4. The UE of claim 1, wherein the processor is further configured to execute the executable instructions to:
update a universal subscriber identity module (USIM) with a GSM CS Kc derived that is derived from a conversion function based on the plurality of CS key parameters.

5. The UE of claim 1, wherein the plurality of CS key parameters comprise a cipher key and an integrity key with a KSI for the CSFB procedure.

6. The UE of claim 1, wherein the processor is further configured to execute the executable instructions to:
in response to a single radio voice call continuity (SRVCC) scheme being active concurrent to, or after, a communication of the extended service request message to originate the CSFB procedure, replacing the plurality of CS key parameters with a plurality of SRVCC key parameters.

7. The UE of claim 1, wherein the processor is further configured to execute the executable instructions to derive the plurality of CS key parameters after an origination of the CSFB procedure independent of an additional authentication operation.

8. A system for circuit switched fallback (CSFB) comprising:
a processing device, comprising a memory storing executable instructions, configured to execute the executable instructions to at least:
determine a security key that enables an authorization or an authentication process;
receive an extended service request message to originate a CSFB process from a first network of a first network device to a second network of a second network device in response to a mobile originating call or a mobile terminating call;
generate a plurality of circuit switched (CS) key parameters from the security key; and
facilitate the CSFB procedure based on the plurality of CS key parameters from the security key.

9. The system of claim 8, wherein the processing device is further configured to execute the executable instructions to:
generate a global system for mobile communications circuit switched cipher key (GSM CS Kc) via a conversion function based on the plurality of CS key parameters.

10. The system of claim 8, wherein the processing device is further configured to execute the executable instructions to:
communicate the plurality of CS key parameters to a mobile switching center (MSC) server component to facilitate the CSFB procedure based on the plurality of CS key parameters from the security key.

11. The system of claim 8, wherein the first network device comprises an evolved-universal mobile telecommunications system terrestrial radio access network (E-UTRAN) device configured to generate the first network as an E-UTRAN, and the second network device comprises a General Packet Radio Subsystem Evolved Radio Access Network (GERAN) device, or a UTRAN device, configured to generate the second network as a GERAN or a UTRAN, respectively.

12. The system of claim 8, further comprising:
an MSC server component communicatively coupled to a user equipment (UE) device, wherein the MSC server component and the UE device are configured to:
generate a GSM CS Kc based on at least one CS key parameter of the plurality of CS key parameters;
determine a key set identifier (KSI) value based on the plurality of CS key parameters; and
assign the KSI value associated with the plurality of CS key parameters to a GSM CS cipher key sequence number (GSM CS CKSN) associated with the GSM CS Kc.

13. The system of claim 12, wherein the first network device comprises an E-UTRAN device and the second network comprises a GERAN device.

14. The system of claim 12, wherein the MSC server component and the UE device are further configured to determine a 128-bit GSM cipher key (Kc₁₂₈) based on the plurality of CS key parameters.

15. The system of claim 14, wherein the MSC server component and the UE device are further configured to assign the KSI value associated with the plurality of CS key parameters to the GSM CS CKSN based on the Kc₁₂₈.

16. The system of claim 8, further comprising:
an MSC server component configured to determine a 128-bit GSM cipher key (Kc₁₂₈) based on the plurality of CS key parameters and communicate the Kc₁₂₈ to the second network device in response to a selection of an encryption process by the second network device.

17. The system of claim 8, wherein the processing device is further configured to execute the executable instructions to:
in response to a single radio voice call continuity (SRVCC) scheme being active concurrent with, or after, a reception of the extended service request message to originate the CSFB procedure, replacing the plurality of CS key parameters with a plurality of SRVCC key parameters.

18. The system of claim 8, wherein the processing device is further configured to execute the executable instructions to:
update a universal subscriber identity module (USIM) with a GSM CS Kc that is based on the plurality of CS key parameters.

19. A computer-readable storage device storing executable instructions that, in response to execution, cause a system comprising a processor to perform operations, comprising:
deriving a plurality of circuit switched (CS) key parameters from a key access security management entity (K_{ASME});
communicating, or receiving, an extended service request message to originate a circuit switched fallback (CSFB) procedure and the plurality of CS key parameters; and
facilitating the CSFB procedure based on the plurality of CS key parameters derived from the K_{ASME}.

20. The computer-readable storage device of claim 19, wherein the operations further comprise:
generating a global system for mobile communications circuit switched cipher key (GSM CS Kc) based on at least one CS key parameter of the plurality of CS key parameters;
determining a key set identifier (KSI) value based on the plurality of CS key parameters; and
assigning the KSI value associated with the plurality of CS key parameters to a GSM CS cipher key sequence number (GSM CS CKSN) corresponding to the GSM CS Kc.

21. The computer-readable storage device of claim 20, wherein the operations further comprise:
in response to a single radio voice call continuity (SRVCC) scheme being active concurrent with, or after, a reception of, or a communication of, the extended service request message to originate the CSFB procedure, replacing the plurality of CS key parameters with a plurality of SRVCC key parameters.
